(19) United States
(12) Patent Application Publication
(10) Pub. No.: US 2012/0265814 A1
(43) Pub. Date: Oct. 18, 2012

(54) Software Application for Managing Personal Matters and Personal Interactions through a Personal Network

(76) Inventor: Stilianos George ROUSSIS, La Jolla, CA (US)

(21) Appl. No.: 13/448,381

(22) Filed: Apr. 16, 2012

Related U.S. Application Data
(60) Provisional application No. 61/475,546, filed on Apr. 14, 2011.

(51) Int. Cl. G06F 15/16

(52) U.S. Cl. 709/204

(57) ABSTRACT

A software application is systems and methods to manage personal matters and personal interactions through a personal network. The personal network includes users, which exclusively share information and activities with each other. The personal network is driven by a personal network engine, which has a plurality of modules that provide different functions for both the users and the software application. Each of the users can manage the events/items in their lives with the software application. The software application can track metrics and performance data for the event/items and can provide coaching suggestions for those event/items, which are based on the metrics and performance data. The software application also allows the users to organize their events/items into classes and their classes into categories.

The current application claims a priority to the U.S. Provisional Patent application Ser. No. 61/475,546 filed on Apr. 14, 2011.

### FIELD OF THE INVENTION

The present invention relates generally to a software application that is capable of managing the information and activities of users in a personal network.

### BACKGROUND OF THE INVENTION

Human interactions and communications have been historically restricted to personal encounters with members of traditional circles such as the family, friends, neighborhood, school, church, work, business, politics, social clubs, and so forth. Meeting new people and opportunities for new experiences has been primarily based on direct introductions or introductions through common, preferably trusted, acquaintances. A major aspect of the interactions and communications for the establishment of new relationships has been the need for some type of trust and confidence that the individuals require in order to reduce the potential risk of the introductions and increase the likelihood of the establishment of successful and mutually beneficial new relationships with previously completely unknown people. Once new relationships are established a great care is typically devoted on the management and quality of the relationships usually involving considerable time and effort between the parties. Relationships where very little effort is made to mutually maintain and nurture each party's needs usually wither and perish.

The advent of computers and the Internet has created unprecedented changes and has created incredible opportunities for introductions of individuals to an unlimited number of people with similar interests through Internet networks established to facilitate the establishment and maintenance of relationships between people with common interests. Such networks include social, dating, business, commerce, political, educational, religious networks, and so forth. Although these networks have an incredible capability to introduce a vast number of individuals in an exceedingly short time, there is often times little or no real personal interaction or direct in-person knowledge of new acquaintances introduced or encountered through the above social networks. In that way, most often individuals and relationships established through these networks never grow beyond the initial introductions and preliminary identification of common interests. The reasons for this fact is an excellent topic for further study, but a practical rationalization may include the fact that the established relationships are not based on the continuous needs and inter-dependencies of the individual people. It appears that at the end, personal involvement and mutual benefits and contributions from any kind of initial introductions, electronic or not, are primordially important for the maintenance and healthy growth of any type of successful relationship.

It is therefore concluded that there are considerable gaps in the currently available electronic networks and their concepts which are primarily focused on public primarily opinion, behavior and information and there is a true and genuine need for the establishment of novel personal networks that extend the traditional and age proven networks between members of the family, friends, neighborhood, school, church, work, business, politics, social clubs, and so forth. Such electronic networks of personal and confidential nature are needed to enable the establishment and maintenance of successful relationships, especially for network members who are physically remote or unable to physically interact with the other members of their close environment. This is often the case for parents and children who live in different cities or countries, for siblings and close friends who for various reasons want but cannot maintain due to the physical distance or other obstacles the relationships they want with their intimate set of people. There is therefore a great need for intimate, close personal communication and relationship maintenance in a proactive and natural way. This is a case where sharing of very private and confidential information between members of the close personal network is highly desired. In this case, the opinions, personal counseling, coaching and encouragement between trusted group members can be exceedingly beneficial to the members themselves and to the society at large.

The present invention describes the system and methods for the management of information and activities of the members of such a personal network. The invention addresses the need to manage personal matters such as current affairs, favorites, personal data, routine chores, home, health, work, money, education, transportation, clothing, entertainment, holidays, trips/vacations, and others, and the ability to selectively share this information and specific activities with a small group of trusted individuals. The invention increases the degree of trust and inter-dependability between group members and allows for the healthy growth and maintenance of successful personal relationships between family members, very close friends, and associates. The invention is applicable in its general case to the management of information and activities of any objective-driven enterprise.

### SUMMARY OF THE INVENTION

Although existing social networks have an incredible capability to introduce vast numbers of individuals in an exceedingly short time, there is often times little or no real personal interaction or direct in-person knowledge of new acquaintances introduced or encountered through the above social networks. Interactions using the currently available social electronic networks and their concepts are primarily based on public opinion, behavior, and information. There is thus a true and genuine need for the establishment of novel personal networks that extend the traditional and age proven networks between members of the family, friends, neighborhood, school, church, work, business, politics, social clubs, and so forth. Such electronic networks of personal and confidential nature are needed to enable the establishment and maintenance of successful relationships, especially for personal network members who are physically remote or unable to physically interact with the other members of their close environment.

The present invention describes the system and methods for the management of information and activities of the members of such a personal network.

The invention addresses the need to manage personal matters such as current affairs, favorites, personal data, routine chores, home, health, work, money, education, transportation, clothing, entertainment, holidays, trips/vacations, and others, and the ability to selectively share this information and specific activities with a small group of trusted individuals. The invention increases the degree of trust and inter-dependability between group members and allows for the healthy growth and maintenance of successful personal relationships between family members, very close friends, and associates. The invention is applicable in its general case to the management of information and activities of any objective-driven enterprise.

### BRIEF DESCRIPTION OF THE DRAWINGS

FIG. 1 is a block diagram illustrating an exemplary personal network system.

FIG. 2 is a block diagram illustrating example modules of the exemplary personal network engine.

FIG. 3 is a flow chart illustrating an exemplary process that is used to create user information.

FIG. 4 is a flow chart illustrating an exemplary process that is used to review and manage of information and activities.

FIG. 5 illustrates an example of a user interface that can be implemented as the main screen (dashboard) of the personal network system.

FIGS. 6A and 6B illustrates example lists of classes for an example list of categories of information or activities, where FIG. 6B is a continuation FIG. 6A.

FIG. 7A illustrates example lists of events/items in example classes of current affairs.

FIG. 7B illustrates example lists of events/items in example classes of personal data.

FIG. 8A illustrates example lists of events/items in example classes of routine chores.

FIG. 8B illustrates example lists of events/items in example classes of health.

FIG. 9 illustrates examples of lists of attributes (FIG. 9A), recognitions (FIG. 9B), proposed options (FIG. 9C), and example metrics (FIG. 9D).

FIG. 10 is a block diagram of an exemplary coaching management module that can be used to create a selected list of proposed options to the user.

FIG. 11 displays the list of components in the personal network case and in the general management case, respectively;

### DETAILED DESCRIPTIONS OF THE INVENTION

All illustrations of the drawings are for the purpose of describing selected versions of the present invention and are not intended to limit the scope of the present invention.

The present invention is a software application that is capable of managing personal matters and personal interactions through a personal network by executing a set of computer-executable instructions. Users can access the present invention through a plurality of user accounts. Each of the plurality of user accounts has a user profile and personal information, which are particular to each individual user account. The personal information includes identification information, contact information, a plurality of events/items, a plurality of categories, a plurality of classes, metrics data, performance data, and audiovisual data, which are described in detail hereinafter. The plurality of user accounts comprises a first user account and other user accounts, which are used to describe any relationships between any one of the user accounts and the rest of the user accounts. A specific user account from the plurality of user accounts can be used to refer to the first user account or any of the other user accounts.

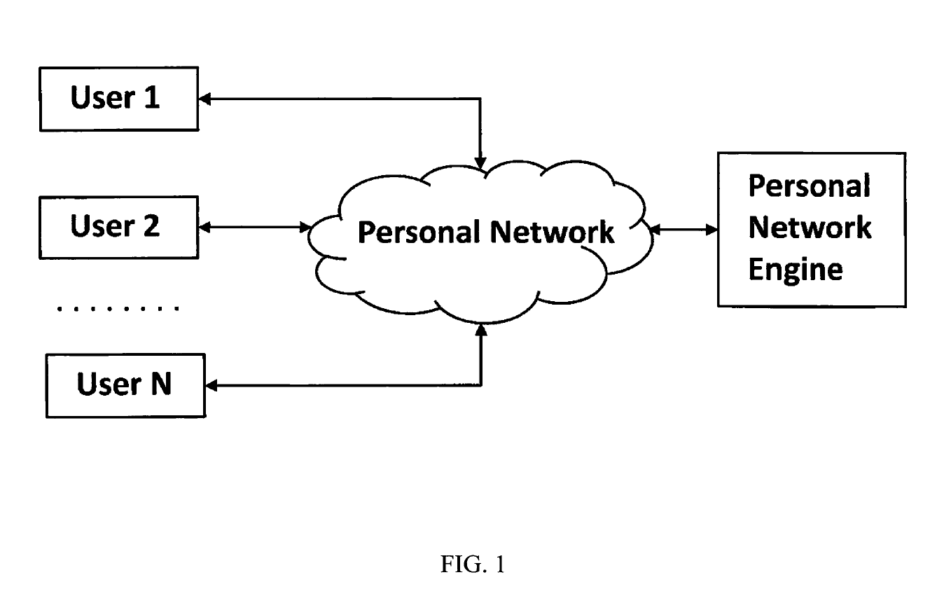

FIG. 1 is a block diagram that illustrates an example of the components of the present invention and possible connections of the user accounts to the personal network and the personal network engine. As an example, the first user account interacts with the personal network engine and other user accounts (e.g., 1, 2, 3, 4, . . . , N) through a personal network. The personal network allows for the connection and communication of the first user account with all other user accounts in the present invention, provided that the first user account has been given their permission to do so. The first user account in that manner is capable of connecting, communicating, and sharing information and activities with all other user accounts that the first user account has been given permission to do so. In addition, the first user account has the capabilities of assigning tasks and activities to selected other user accounts on the personal network and share all information and activities that the other user accounts allow the first user account to share with them. Other user accounts can also assign tasks and activities to the first user account and share information with the first user account, provided that the first user account has given the other user accounts permission to do so. In addition, the first user account also has the capability to manage their personal information and activities by sharing or not its items/events with the other user accounts.

The present invention allows for the selection of which individual item/event is shared and with which user account. For example, a particular event/item may only be shared with the second user account, and another event/item may only be shared with the third user account. The second user account will not see the other event/item that the first user account has shared with the third user account. Similarly, the third user account will not see the particular event/item that the first user account shared with the second user account. In this way, the present invention allows for the selective sharing of personal information with specific user accounts of choice. For example, parents will be able to share particular information between themselves and not with their children. At the same time, parents will be able to share other information and activities with their children and themselves. A user account allows an individual to track and manage their personal information of a confidential nature (e.g., health, financial information, etc) and share this information with no one but him/herself.

The other user accounts that are associated with the first user account are members of the personal network of the first user account. The first user account or any of the associated members in the personal network can discontinue their connection to the personal network of the first user account and is able to do so at any time. At that time, the connections are interrupted and each user account ceases to belong to the respective personal network of the respective user. Establishment of a new connection between the two members is possible but requires one user account to initiate a new connection with an invitation and another user account to accept the invitation. All information that is associated with the previous connection between two user accounts is typically erased and new information is needed to establish a new relationship between the two user accounts.

The users may access their user account in order to connect to the personal network and the personal network engine by using any available electronic device that permits such a communication. Examples of electronic devices include but are not limited to personal computers, desktop computers, laptops, telephones, personal assistants, smart-phones, tablet personal computers, and so forth. These electronic devices and other suitable devices may be used to enter, edit, and manage connections and information between user accounts in the present invention.

The personal network is connected to and is driven by the personal network engine. The personal network engine may reside on one or more servers or on the hard drive of computers or other devices that are appropriate for the storage of the personal network engine. The personal network engine may comprise a website, servers or other storage devises, and any other devices or applications able to provide networking capabilities. The user accounts access the services provided by the personal network engine through the personal network. There are optional possibilities for user accounts to directly access the personal network engine.

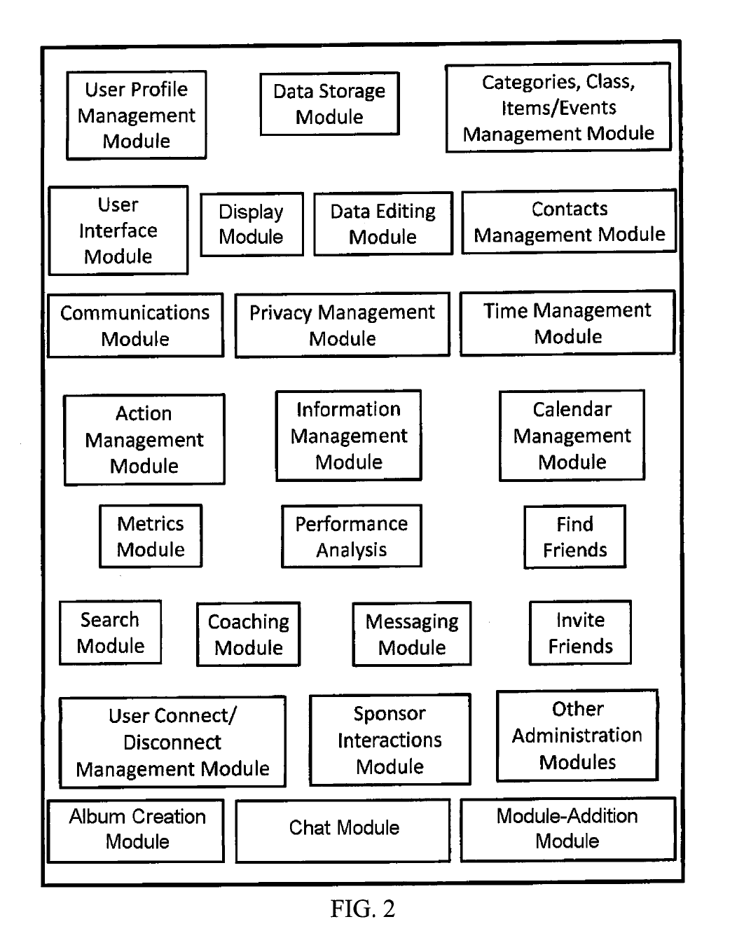

FIG. 2 is a block diagram that illustrates a plurality of possible modules in a personal network engine, which is discussed in FIG. 1. The plurality of modules is not exhaustive and is given only as an example of possible modules that can be used in a personal network engine. Other modules not shown in FIG. 2 may be also added as needed for the function of the personal network engine. As an example, a user profile management module is used to create the user profile by retrieving identification information and contact information from a user account. The identification information and the contact information allows the personal network engine to identify each of the user accounts in the personal network (e.g., name, photo, etc). The user profile management module is also used to communicate with a user account (e.g., send reminders, messages from other users, etc). The user profile management module also allows the user account to review and edit the user profile by editing the identification information and the contact information. As another example, a data storage module is used to store the user information and other information for the plurality of modules. The data storage module can be comprised by all appropriate hardware (servers, hard disks, etc.) and software (e.g., programs, applications, etc) devices required to enable the storage of the data and programs used by the system.

A user interface module allows a user account to review, create, edit, and manage all information and activities in the present invention. The user interface module also allows the user account to input commands for the personal network engine. A data editing module is provided to allow the user account to add, delete, modify, and perform any other editing action on the user information. For example, the data editing module permits the creation of new categories, new classes, and new events/items as desired by the user account. A communications module allows a user account to communicate with the present invention. The means of communication are flexible and include but is not limited to desktop computers, laptops computers, telephones, mobile telephones, smart-phones, and tablet personal computers. The purpose of the communications module is to transfer information between the user and the personal network engine. For example, the communications module allows the present invention to send reminders or messages to the user using suitable hardware and software devices. Similarly, the communications module allows the user may to connect to the personal network engine via suitable hardware or software devices to review, create, or modify the information on the present invention. An important feature of the communications module is the ability of the first user account to initiate or to respond to an action triggered by the first user account or by any of other user accounts that could assign the action to the user. The communications module allows the plurality of user accounts to communicate with each other via the personal network engine.

A display module is provided that is associated with the personal network engine. The display module allows the user accounts to access all options and window screens available by the present invention. The main screen is used as a dashboard for a user account and allow the user to access all parts of the software application. The main screen also allow the user to access subsequent screens, which include but is not limited to a user profile screen, a categories screen, a classes screen, a view-event/item screen, an add-event/item screen, a find-friend screen, a list-of-contacts screen, a search screen, a calendar screen, a messages screen, a sponsor screen, a metrics screen, and a performance screen. Other screens may be added as needed for the function of the software application. The various screens provided by the display module contain options for the user account to review, add, modify, delete, etc. information as needed for each particular screen.

An events/items management module allows a user account to manage a plurality of events/items. The events/items management module also allows the user account to organize the plurality of events/items into a plurality of classes and to organize the plurality of classes into a plurality of categories. Typical categories include but is not limited to areas of personal matters such as current affairs, favorites, personal data, routine chores, home, health, work, money, education, transportation, clothing, entertainment, holidays, trips/vacations, and so forth. The user account may create new categories as deemed appropriate. Each category further contains individual classes created by the user account as deemed appropriate. As can be seen in FIG. 7, under the current affairs category, the possible classes may include the top ten current interests, the top ten current activities, the current and upcoming events, the top ten currents things, and so forth. For each class in each category, the events/items management module is primarily used to manage the plurality of events/items. As an example, baseball, politics topic #, politics topic 3 may be some of the individual events/items in a user's top ten current interests class in the current affairs category. The event/items management module also allows the user account to add individual comments, photos, videos, file attachments, links, hyperlinks, and any other type of information to any of the events/items.

The events/items management module allows the user account to manage the categories, the classes in each category, and the events/items in each class. The user account is able to review, add, edit, delete, update, etc. individual events/items in selected classes of selected categories. The user account is also able to review, add, edit, delete, etc. individual classes of selected categories. In a similar fashion, the user account is able to review, add, edit, delete, update, etc selected categories in its user information.

A contacts management module is provided as a part of the personal network engine. For example, the contacts management module compiles an active list of contacts that are connected with the first user account. The list contacts is updated each time the first user account creates a new connection with a new user account and each time the user account disconnects from another user account. The contacts management module provides the first user account with the list of contacts every time the first user account decides to share its user information or its activities with the other user accounts.

A privacy management module allows the first user account to maintain the privacy of its user information or its activities for the other user accounts. The privacy management module allows the first user account to separate the user information into public information, selectively public information, and private information. The private information can only be accessed by the first user account and is the default option for the user information. The public information can be shared with all of the other user accounts. The selectively public information is exclusively shared with a number of privy user accounts. The privacy management module prompts the first user account to choose the privy user accounts from the other user accounts. An example of the first user account using selectively public information is to create a surprise event/item for a second user account. In that case, the first user account may organize events/items with the privy user accounts for the second user account, but the second user account cannot view or access the information related to the planned surprise event/item, which is being organized by the privy user accounts. The privacy management module provides the management of these privacy conditions for each event/item of the first user account.

A time management module allows a user account to create and manage time related information or activities. The time management module enables the user account to input a start date and an end date. The user account can also leave events/items without a start end and an end date. For events/items with a start date and an end date, the time management module allows the user account to input a repetition frequency, which indicates how often the event/item should be repeated within a schedule. For any event/item, the time management module provides the user account with the option to set reminders with various frequencies. Such reminders will be sent to a specific user account, which is selected by the user account at a pre-selected date and at a pre-selected frequency.

An action management module allows a user account to set a required action of a specific event/item for a specific user account and alerts the specific user account to the required action that needs to be taken for the specific event/item. For example, the first user account may assign a particular event/item to a specific user account for a particular date. When the first user account is creating the particular event/item, the first user account will also select a target date, a repeat frequency, reminders, and a frequency of reminders. The first user account must also specify if a required action needs to be done by the second user account for the particular event/item and what is involved in the required action. The specific user account will then be alerted by the action management module to the required action of the specific event/item. In that case, a color code will be used to distinguish the nature of the specific event/item (for example, red for events/items that have yet to complete the required action, blue for events/items that are used only for information, and black or grey for events/items that have been completed). A numerical system within the action management module is used to track the list of events/items that have a required action and is used to issue the appropriate alerts or reminders as set by the first user account.

Upon the completion of an assigned event/item, the specific user account may change the status of the event/item to complete. Typically, the initial status for an event/item is set to new. The specific user account also has the option to reject an assigned event/item.

An information management module is used to manage the information created by a first user account in the present invention for each event/item in each class of each category. For each event/item, the first user account enters a descriptive title for a specific event/item that differentiates the specific event/item from all of the other events/items in its class. The first user account may enter a detailed description for the specific event/item, which the first user account may share with anyone on its list of contacts. The details of each event/item are accessible to the first user account directly from the dashboard or from the individual display screens of the classes of each category. The details of each event/item may include but is not limited to a detailed description, comments, attachments of files, photos, videos, links, hyperlinks, and so forth. The first user account may also review the details that are created for each event/item by the other user accounts. However, the first user account may not edit the details created by other user accounts. The first user account can only review, take action, and reply to events/items that are created by other user accounts.

A metrics module allows the personal network engine to manage the metric data related to the optional ratings that are provided by the first user account and the other user accounts for shared events/items. As an example of a metric, a statistical average or a cumulative total may be tracked by the metrics module for each event/item and can be reviewed by all user accounts, which have permission to do so, along with the comments, the descriptions, and the other details of each event/item. This information becomes available to all user accounts that have permissions within a given personal network. Each user account cannot share information that they have not created. The metrics module may use other appropriate numerical means to track information related to the rating of individual events/items.

A performance module allows the personal network engine to track the performance of each user account. As an example of the performance analysis done on each user account, the performance analysis module tracks the total number of completed events/items completed by the first user account for each of the other user accounts in terms of class, category, and the grand total, which provides absolute and relative performance data for the degree of performance with each of the other user accounts. The performance data may be coupled with the metrics data. Numerical or graphical means is used to the performance data and the metrics data to the first user account. The performance data and the metrics data may be used by the first user account and other modules of the personal network engine to derive information that is related to possible options, which are available to meet the requirements of any given assigned event/item by the first user account for any of the other user accounts.

A calendar module is used to track and manage information using conventional means of time management. More specifically, the calendar module also allows a user account to track and manage the start date, the end data, the repetition frequency of each event/item. Events/items may be sorted based on calendar dates. Events/items in the calendar dates may be ranked based on the other user accounts. Events/items may be identified and tracked by the start date, the end date, or the actual occurrence date. The calendar module of the personal network system may be interfaced with the calendars of other popular software (e.g., Outlook, Google, Notes calendars, etc).

A search module allows a user account to search through the events/items of each user account on the personal network by keywords or other searching methods. The search results can be sorted by keyword matching, user names, dates, etc. The search module can only search the user information of the user accounts within the personal network. Furthermore, a first user account can only search information of events/items that other user accounts in its personal network have given permission to do so. The privacy management module prevents a user account to search through the events/items of all of the user accounts. Only events/items that are shared with a particular user account will be show up in the search results. The search module also allows a user account to search for information related to sponsors, the sponsor's websites, the sponsor's products, and the Internet in general.

A coaching module provides options and suggestions to user accounts as needed. As an example and not as a complete description of all features or capabilities of the coaching module, the coaching module may provide reminders related to the frequency of communications between users and, thus, proactively enhance the degree of relationships between user accounts. People often neglect the maintenance of personal relationships because of other life priorities. The coaching module provides the means of improved management of personal relationships. Information used by the coaching module may be derived from the user's own information available to the personal network engine, general network knowledge, public (e.g., Internet) knowledge, expert knowledge, and so forth. The rules selected by the user account or available from the coaching module may be used to propose possible options to the user account in a pro-active and time effective manner. The performance of the actions based on the use of the coaching module may be tracked by the metrics module and performance analysis module.

A messaging module to enables the user accounts to send and receive message communications to each other. Message communications from a first user account may be sent directly to the other user accounts within the personal network. The messaging module also notifies of a user account when it receives a message communication. For example, an email or a voice mail may be sent to the user account about a new message communication and would contain a link or a reply number for the user account to check and review the new message communication. Similar notifications are sent from the personal network engine to a user account about information events/items assigned to or shared with the user account. Message communications may be only conducted between the user accounts that belong to same personal network. Moreover, a user account that belongs to a different personal network will not see all message communications. The user account that belongs to the different personal network will see only the aggregate messages of the user account who created the message communication and who are within their own personal network. Message communications or information created by user accounts outside of the personal network will not be seen by the user account, even if there are common users between the different personal networks. A chat module allows the user accounts within the same personal network to chat with each other by exchanging instantaneous communications. The instantaneous communications between the user accounts can be done either through text, audio, or video.

An album module allows a user account to create an album and allows the user account to organize its audiovisual data into the album. The audiovisual data includes but is not limited to photographs and videos and is retrieved from the user account with the user interface module. The album module also allows the user account to share its audiovisual data with the other user accounts within the personal network.

A find-friend module allows a user account within the personal network to search for a new user account (e.g., family, close friends, and associates), which does not have access to the personal network. An invite-friend module allows the user account to send an invitation to the new user account so that the new user account can start to use the services of the personal network engine. The invitation will prompt the new user account to join the personal network, and if the new user account accepts the invitation, then the new user account will be added to the user accounts within the personal network. Initially, a person can also register with a new user account in order to use the services of the personal network engine. The new user account can then invite other people to register, which would create other new user accounts. A user connect/disconnect module is available to manage the connections with new user accounts and to interrupt existing connections. A sponsor interactions management modules is available along with other administration modules for the management of the various other functions of the personal network engine. A module-adding modules retrieves new utility modules for the personal network engine. The new utility modules are added to the plurality of modules so that the user accounts can access them. The new utility modules can be created by different software developers and add new functions to the present invention.

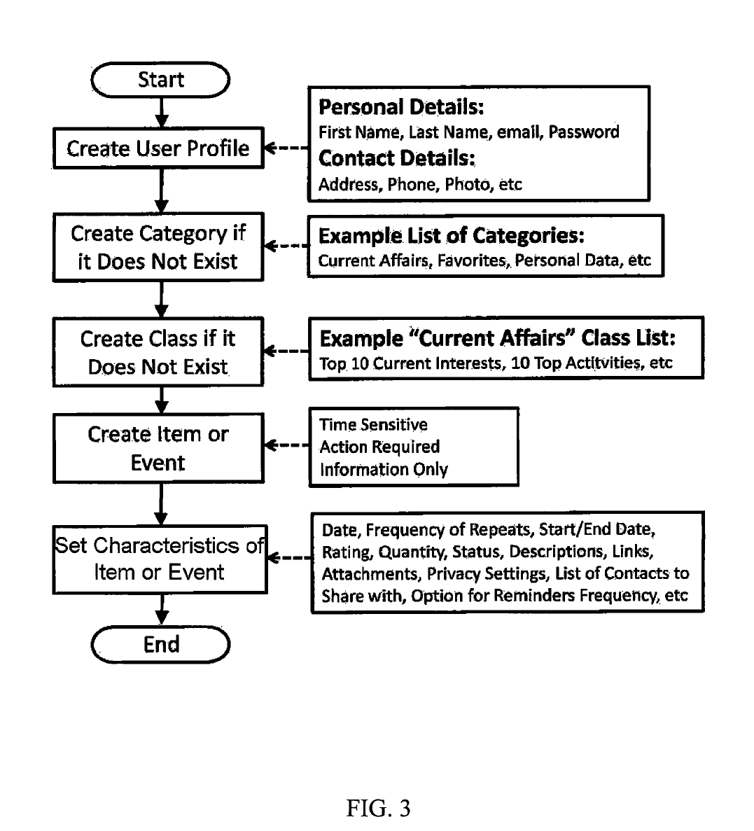

FIG. 3 is a flow diagram that displays an example of a process used to create the user information. Initially, a user profile is created by the first user account. Typical identification information and contact information required for the creation of the user profile includes a first name, a surname, an email address, a password, etc. Optional contact information and identification information includes an address, a telephone number, a photo, etc. The user profile is used by the present invention to differentiate the first user account from the other user accounts and for the first user account to create a unique identity within the personal network system, which can be recognized by the other user accounts.

Once a user profile is created, the first user account may create a new category to add to its plurality of categories if the first user account finds it necessary. Similarly, the first user account can create a new class to add to the plurality of classes if one of its choice does not already exist. For each class in each category, the first user account can then create a new event/item. Events/items may be time sensitive, may have some type of required action, or may only be for information purposes.

Depending on the nature of the events/items, a plurality of characteristics can be defined by the first user account for each event/item. The plurality of characteristics includes but is not limited to an occurrence date, a target date, a repetition frequency, a start date, an end date, a rating, a quantity, a status, a detailed description, links, attachments, privacy settings, a list of privy user accounts, reminder frequency options, a recognition data, and so forth.

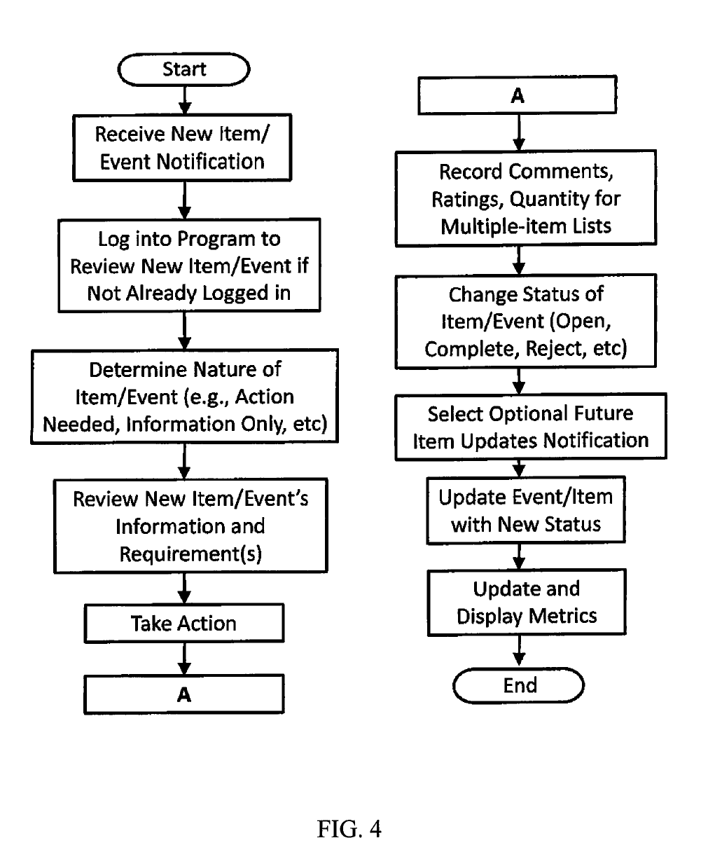

Once the new category, the new class, and the new event/item is created, they can be reviewed by the first user account. FIG. 4 displays a flow chart that illustrates an example of a process for the review and management of information and activities by the first user account using the personal network engine. Once a new event/item is created by the personal network engine, a notification is sent to a specific user account with brief information about its nature (e.g., title, sender, etc) by the messaging module. A link or reply number is provided within the notification, which will prompt the specific user account to view the new event/item. The specific user account can then access the personal network engine, which will display the new event/item to the specific user account with the display module. The specific user account can then determine the nature of the new event/item (e.g., action required, for information only, etc). At this stage, the specific user account may obtain further and more detailed information about the specific event/item by reviewing its detailed description and its required action. Next, the specific user account may take action and update the status of the specific event/item, which can be marked as open, completed, or rejected. If the status of the specific event/item is complete, then the specific user account will input a recognition data, which describes what was done to complete the specific event/item. The specific user account can also input a rating that is associated with the event/item. If the event/item cannot be immediately completed, then the specific user account may leave the status of the specific event/item as new or open, until the specific user account can set the status as complete and provide a rating for the specific event/item. The specific user account can then record comments and provide a rating with regards to the completed event/item. In case the specific user account considers the specific event/item as futile, then the specific user account can set the status of the specific event/item as rejected. The originator of the event/item may optionally view the rejected status of the specific event/item. The specific user account may also provide some type of description that justifies the rejected status of the specific event/item, which can be shared with the originator of the specific event/item. A rating from both the specific user account and the originator can provide a numerical value of the specific event/item. The performance data of the specific user account is updated by recording the specific event/item as a completion. Notifications about future updates related to this specific event or item may be optionally selected at this stage by the originator. At this end of this process, the new information and metrics data are updated and optionally displayed to the originator.

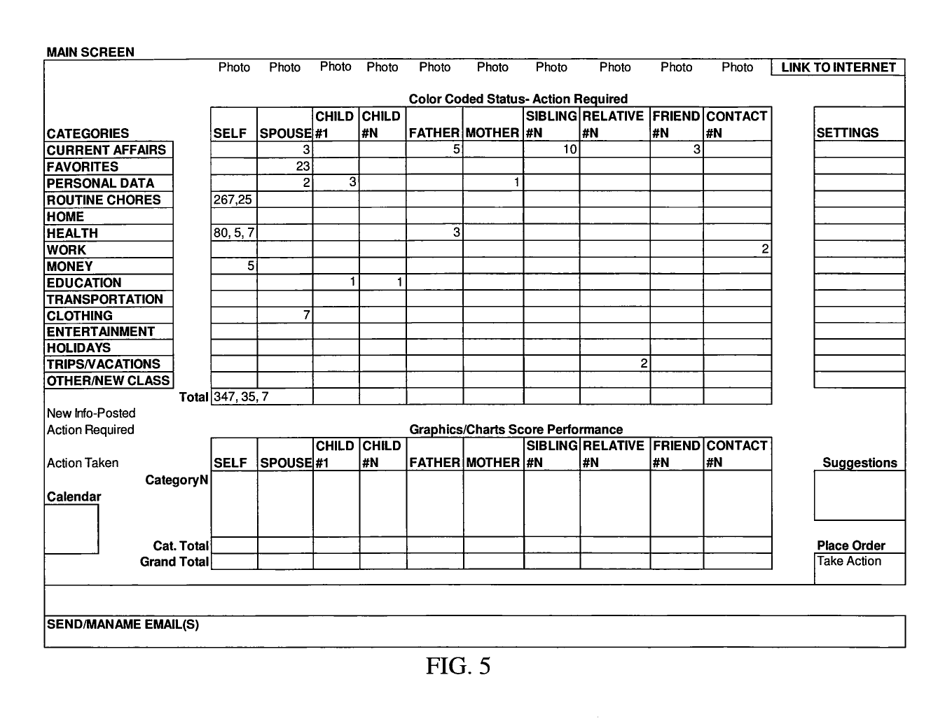

FIG. 5 illustrates an example of a user interface that may be implemented as the main screen (dashboard) for the present invention. Using the main screen, a first user account may access all available program screens and features. The main screen displays the plurality of categories. An initial list of categories is provided to the first user account by the present invention, but the first user account can create additional categories as needed. Other user accounts in the main screen are identified by their names and optional photographs. The relationships between the first user account and each of the other user accounts are typically not displayed and are not explicitly described. Events/items are color coded for easy recognition (e.g., red for events/items that have yet to complete the required action, blue for events/items that are used only for information, and black or grey for events/items that have been completed). Events/items are tracked as cumulative totals for each category by each user account, including the first user account. The first user account can manage events/items assigned to itself and be able to assign or share events/items with other user accounts. Numerical and or graphical tracking of the performance data and metrics data can be displayed on the main screen. Additional features are also available in the main screen (e.g., messaging, calendar, searching, access to other parts of the program, etc).

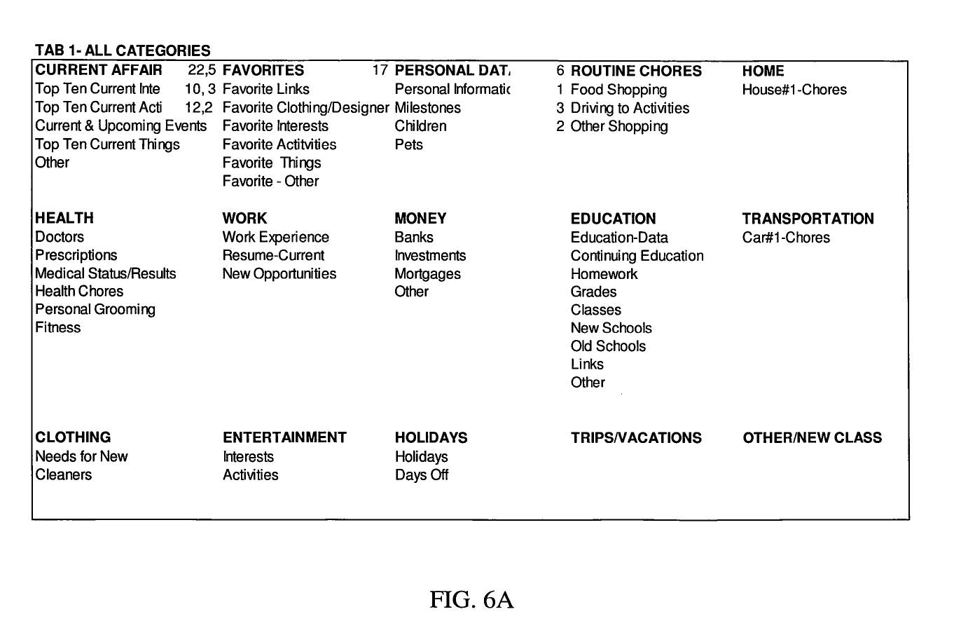

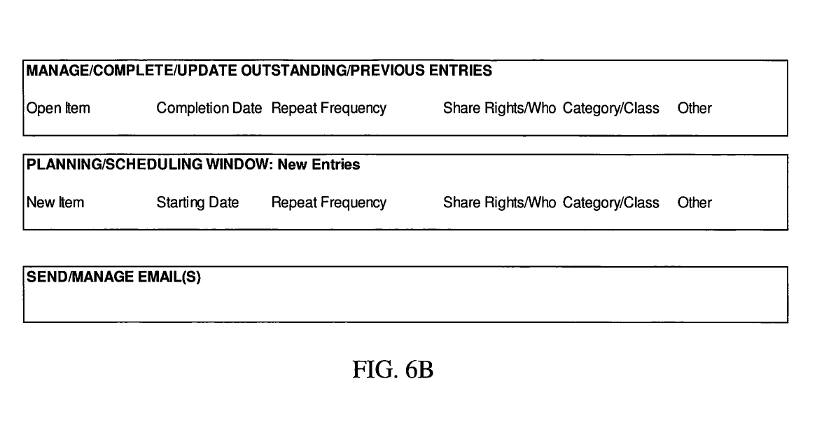

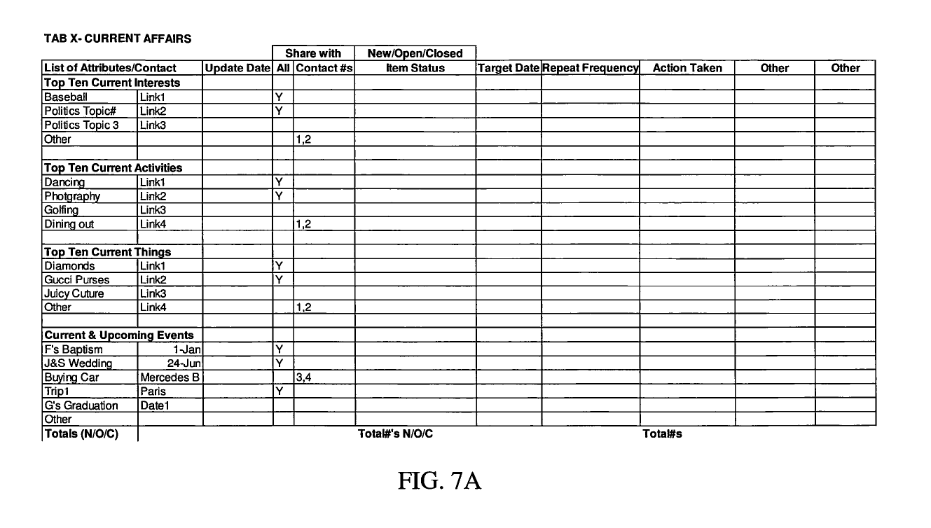

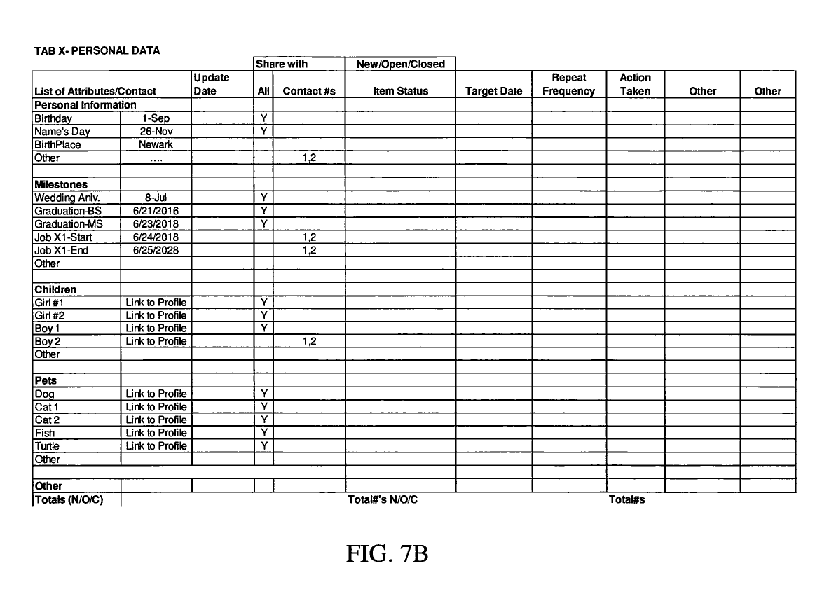

FIG. 6 illustrates an example lists of classes for a list of categories of information or activities. Example classes are given for a list of categories of events/items. As an example and not as an exhaustive list under current affairs, the following classes may be used: top ten current interests, top ten current activities, current & upcoming events, etc. Similarly, different classes as required may be created for other categories. A screen can be displayed for the first user account to create, edit, delete, and manage the list of classes. Additional optional features may include messaging capabilities, calendar capabilities, searching capabilities, access to sponsors links, and others.

FIG. 7A illustrates example lists of events/items in the example classes of current affairs. As an illustration and not as an exhaustive list of events/items in the top ten current interests class, the following events/items may include baseball, politics topic#, politics topic 3, etc. Each event/item has specific characteristics such as links, attachments, dates, list of privy user accounts, reminders, frequencies of reminders, types of actions, detailed descriptions, and so forth. A second example is given in the bottom of FIG. 7B, which contains similar events/items with their corresponding characteristics for the personal information data class of the personal data category. The specific events/items, information, and management are totally user dependent. The user account has complete control as to which events/items are created and how those events/items are shared and managed.

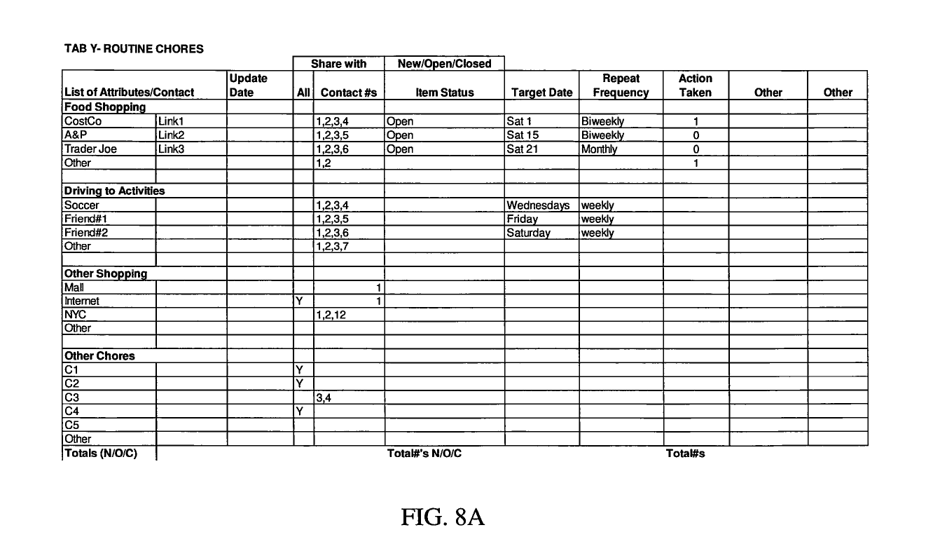

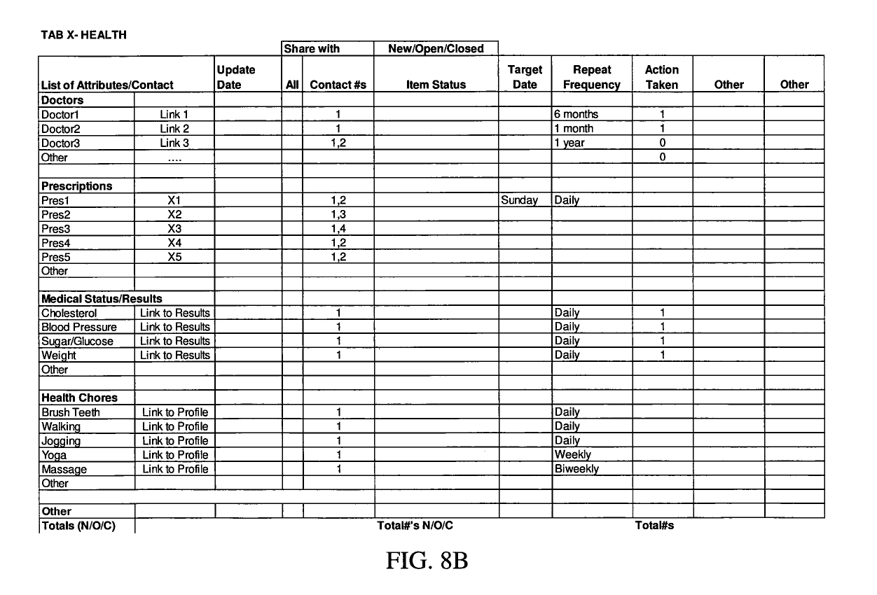

FIG. 8A illustrates example lists of events/items in example classes of routine chores. Examples of events/items in the classes of food shopping, driving to activities, other shopping, and other chores are shown in FIG. 8A as part of the category for routine chores. For the category of health, examples of events/items are shown in FIG. 8B for the classes of doctors, prescriptions, medical status/results, health chores, and other.

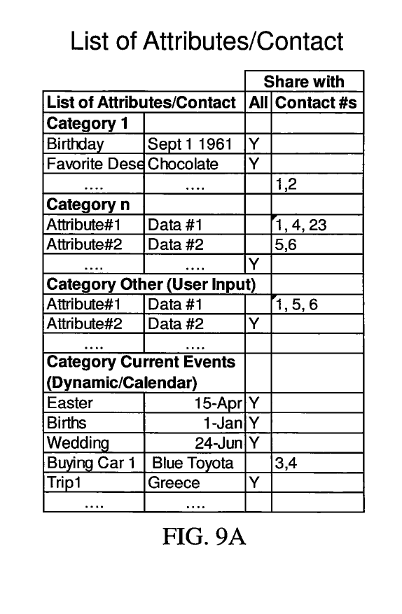

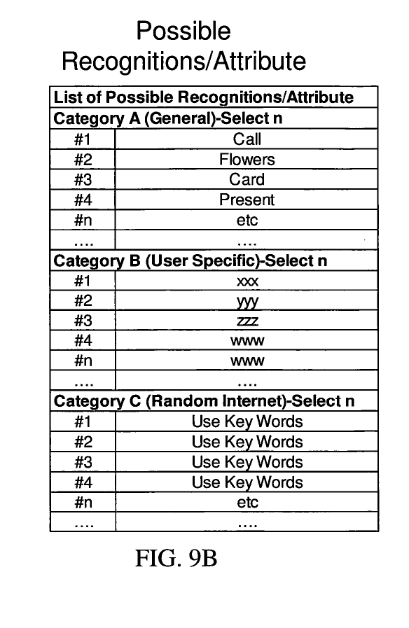

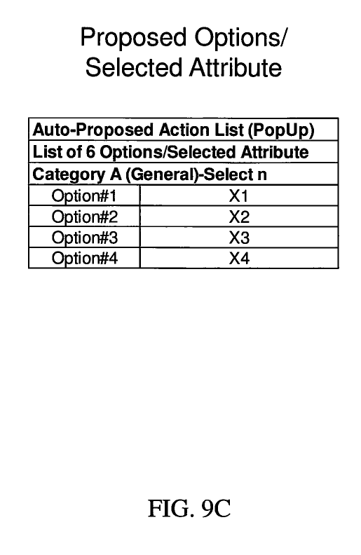

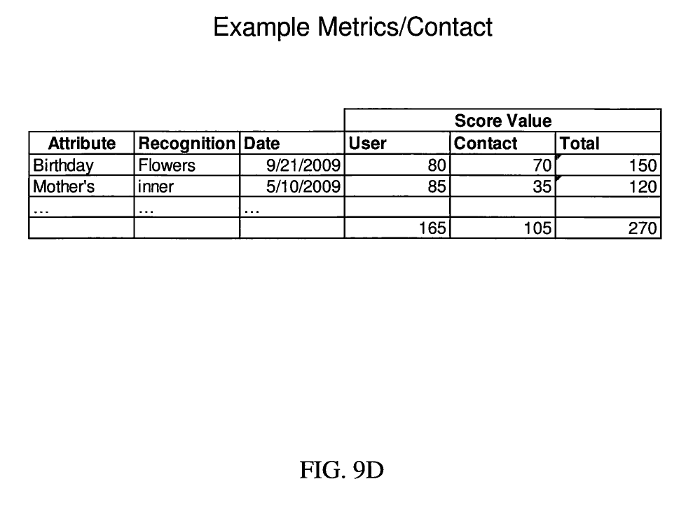

FIG. 9 illustrates examples of lists of attributes, recognitions, proposed options, and example metrics. An attribute for a user account can be a category, a class, and an event/item. One table in FIG. 9A illustrates examples of a list of attributes per contact. For example, birthday is one possible attribute of a contact. Another example is the favorite desert of the contact. Similar attributes may be generated and classified in different classes and categories. Events/items may be attributes of classes and categories and they can be selected using a calendar or directly set by the user account. Examples are given in a table in FIG. 9B of a list of possible recognitions per attribute per contact or user. For example, making a telephone call, sending flowers, sending a personal card, sending a present, etc are illustrations of possible ways to recognize and meet the expected requirement of an event/item. The list of possible recognitions per attribute can be user-specific and be defined by the user, they can be selected randomly from information obtained from the Internet, or may be derived from some other source such as from existing information in the personal network, expert opinion, or any other source of knowledge. A list of proposed options shown in FIG. 9C can be presented to the user account for each selected attribute for each user account. The list of proposed options can be automatically proposed to the user account in a manner set by the user account or by the personal network engine. The personal network engine also allows for the manual selection of options, as already described in previous sections of this invention disclosure. Another table in FIG. 9D displays example metrics obtained for each contact or user. As an illustrative example and not as a specific example about the metrics module of the engine, the sending of flowers from one user to another user on the event of one user's birthday received a score of 80 by the sender user and a score of 70 by the receiver contact. As an example, a total or average metric may be maintained by the present invention.

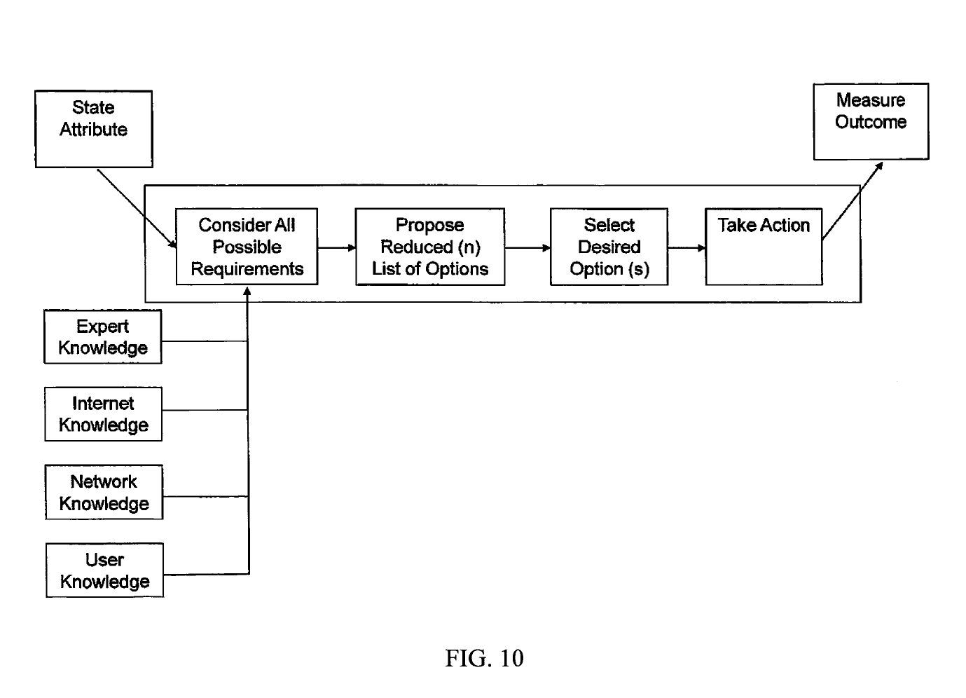

FIG. 10 is a block diagram of an exemplary coaching management module that can be used to create a list of proposed options to a user account. As an example of a possible module for the engine driving the coaching module, knowledge may be derived from all possible sources. For example, potential sources may include user knowledge from the user's personal network, knowledge from the personal network, knowledge from the Internet, knowledge from experts, and so forth. The process in the coaching module considers all possible requirements and uses all available knowledge to create a reduced and more manageable list of proposed options for the user account. The user account will then be prompted to select one or none of the proposed options generated by the coaching module. The user may then take action based on the selection of the proposed option. A metric and performance data is finally generated and recorded by the personal network engine that reflects the opinion of the user and/or the contact about the action taken. The metric may be used to provide additional personal user-derived knowledge in considerations for future selection of user options.

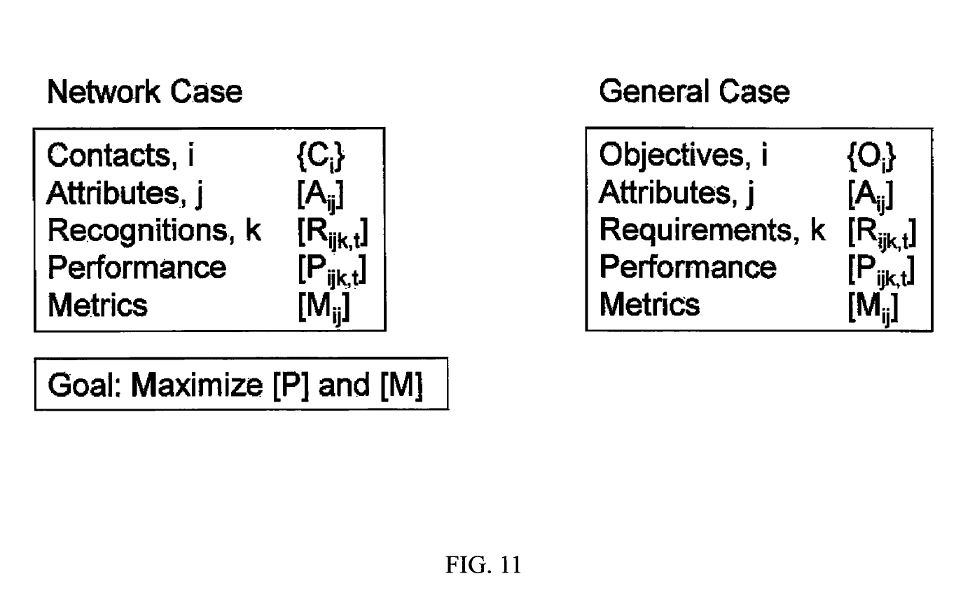

FIG. 11 displays the list of components for the management of information and activities in the personal network case and in the general management case, respectively. The personal network system may be described in mathematical terms as follows. In the personal network case, there is a list, {Cᵢ} of contacts or users, i. Each contact or user, i has j attributes, which can be described in a matrix form as [Aᵢⱼ]. For each attribute, j of contact or user, i there are k, recognitions or requirements, usually time dependent (t), in a matrix form [R_{ijk,t}]. For each recognition or requirement there is a corresponding performance assigned, in a matrix form [P_{ijk,t}]. For each attribute, j of each contact or user i, there is a total metric in a matrix form [Mᵢⱼ].

In the general case, there is a list {Oᵢ} of objectives, i. Each objective, i has j attributes which can be described in a matrix form as [Aᵢⱼ]. For each attribute, j of objective i, there are k requirements, usually time dependent (t), in a matrix form, [R_{ijk,t}]. For each requirement there is a corresponding performance assigned, in a matrix form, [P_{ijk,t}]. For each attribute, j of each objective, i there is a total metric in a matrix form [Mᵢⱼ]. In both management cases, the objective is to maximize the [P] and [M] matrices.

The approach in its general case allows for the supervised management of any objective driven activity such as a home project or a work-related assignment.

Although the invention has been explained in relation to its preferred embodiment, it is to be understood that many other possible modifications and variations can be made without departing from the spirit and scope of the invention as hereinafter claimed.

What is claimed is:

1. A method of managing personal matters and personal interactions through a personal network by executing computer-executable instructions stored on a non-transitory computer-readable medium, the method comprises the steps of:
providing a personal network engine, wherein said personal network engine includes a plurality of modules;
providing a plurality of user accounts, wherein each of said plurality of user accounts includes a user profile and user information;
providing a first user account and other user accounts, wherein said plurality of user accounts comprises said first user account and said other user accounts;
providing a specific user account from said plurality of user accounts, wherein said specific user account can be said first user account or any of said other user accounts;
enabling said plurality of user accounts to exclusively interact with each other through said personal network, wherein said personal network is driven by said personal network engine;
enabling each of said plurality of user accounts to access said plurality of modules through said personal network, wherein said plurality of modules includes a user profile management module, a user interface module, a display module, a data storage module, a data editing module, a contacts management module, an event/item management module, a communications module, a privacy management module, a time management module, an action management module, an information management module, a calendar management module, a metrics module, a performance analysis module, a search module, a coaching module, a messaging module, a find-friend module, an invite-friend module, an album module, a chat module, and a module-adding module;
storing said user information of each of said plurality of user accounts within said data storage module, wherein said user information includes identification information, contact information, a plurality of events/items, a plurality of categories, a plurality of classes, metrics data, performance data, and audiovisual data;
managing said user information of each of said plurality of user accounts with said plurality of modules; and
enabling each of said plurality of user accounts to manage a specific event/item from said plurality of events/items with said event/item management module, wherein each of said plurality of events/items includes a plurality of characteristics.

2. The method of managing personal matters and personal interactions through a personal network by executing computer-executable instructions stored on a non-transitory computer-readable medium, the method as claimed in claim 1 further comprises the steps of:
enabling each of said plurality of user accounts to create said user profile with said user profile management module by retrieving said identification information and said contact information; and
enabling each of said plurality of user account to review and edit said user profile through said user profile management module by editing said identification information and said contact information with said data editing module.

3. The method of managing personal matters and personal interactions through a personal network by executing computer-executable instructions stored on a non-transitory computer-readable medium, the method as claimed in claim 1 further comprises the steps of:
enabling each of said plurality of user accounts to input commands for said personal network engine with said user interface module; and
enabling each of said plurality of user accounts to communicate with said personal network engine through said communications module.

4. The method of managing personal matters and personal interactions through a personal network by executing computer-executable instructions stored on a non-transitory computer-readable medium, the method as claimed in claim 3 further comprises the steps of:
enabling each of said plurality of user accounts to send message communications to each other with said messaging module;
enabling each of said plurality of user accounts to receive message communications from each other with said messaging module; and
enabling each of said plurality of user accounts to exchange instantaneous communications to each other with said chat module.

5. The method of managing personal matters and personal interactions through a personal network by executing computer-executable instructions stored on a non-transitory computer-readable medium, the method as claimed in claim 1 further comprises the steps of:
organizing said plurality of events/items for each of said plurality of user accounts into said plurality of classes with said event/item management module; and
organizing said plurality of classes for each of said plurality of user accounts into said plurality of categories with said event/item management module.

6. The method of managing personal matters and personal interactions through a personal network by executing computer-executable instructions stored on a non-transitory computer-readable medium, the method as claimed in claim 5 further comprises the steps of:
prompting each of said plurality of user accounts to create a new category with said event/item management module;
adding said new category to said plurality of categories with said data editing module;
prompting each of said plurality of user accounts to edit or remove a specific category from said plurality of categories with said event/item management module; and
editing or removing said specific category with said data editing module.

7. The method of managing personal matters and personal interactions through a personal network by executing computer-executable instructions stored on a non-transitory computer-readable medium, the method as claimed in claim 5 further comprises the steps of:
prompting each of said plurality of user accounts to create a new class with said event/item management module;
adding said new class to said plurality of classes with said data editing module;
prompting each of said plurality of user accounts to edit or remove a specific class from said plurality of categories with said event/item management module; and
editing or removing said specific class with said data editing module.

8. The method of managing personal matters and personal interactions through a personal network by executing computer-executable instructions stored on a non-transitory computer-readable medium, the method as claimed in claim 5 further comprises the step of:
systematically displaying said plurality of categories, said plurality of classes, and said plurality of events/items for each of said plurality of user accounts on a main screen, wherein said main screen is produced with said display module.

9. The method of managing personal matters and personal interactions through a personal network by executing computer-executable instructions stored on a non-transitory computer-readable medium, the method as claimed in claim 1 further comprises the steps of:
enabling said first user account to assign and exclusively share said specific event/item to a specific user account;
enabling said first user account to select said plurality of characteristics for a specific event/item, wherein said plurality of characteristics comprises a status, a recognition data, and a rating;
displaying said specific event/item to said specific user account with said display module;
prompting said specific user account to update said status for said specific event/item, wherein said status can be open, complete, or rejected;
updating said performance data of said specific user account by recording said specific event/item as a completion for said first user account with said performance analysis module, if said status of said specific event/item is complete;
retrieving recognition data of said specific event/item from said specific user account;
retrieving said rating of said specific event/item from said specific user account, if said status of said specific event/item is complete;
updating said metrics data of said specific user account with said rating for said second user account with said metrics module;
displaying said metrics data of said specific user account to said second user account with said display module;
displaying said recognition data of said specific item/event to said first user account, if said first user account is not said specific user account;
retrieving said rating of said specific event/item from said first user account, if said status of said specific event/item is complete and said first user account is not said specific user account;
updating said metrics data of said first user account with said rating from said first user account with said metrics module; and
displaying said metrics data of said first user account to said first user account with said display module.

10. The method of managing personal matters and personal interactions through a personal network by executing computer-executable instructions stored on a non-transitory computer-readable medium, the method as claimed in claim 9 further comprises the steps of:
enabling each of said plurality of user accounts to create a new event/item with said event/item management module;
enabling each of said plurality of user accounts to create a descriptive title and a detailed description for said new event/item with said information management module;
adding said new event/item to said plurality of events/items with said data editing module;
sending a notification for said new event/item to each of said plurality of user accounts with said message module;
prompting each of said plurality of user accounts to access said personal network engine in order to view said new event/item; and
displaying said new event/item to each of said plurality of user accounts with said display module.

11. The method of managing personal matters and personal interactions through a personal network by executing computer-executable instructions stored on a non-transitory computer-readable medium, the method as claimed in claim 9 further comprises the steps of:
enabling said first user account to set reminders for said specific event/item with said time management module;
enabling said first user account to set a start date and an end date for said specific event/item with said time management module;
enabling said first user account to set a repetition frequency for said specific event/item with said time management module;
alerting said specific user account to said reminders of said specific event/item with said time management module;
alerting said specific user account to said start date and said end date of said specific event/item with said time management module; and
alerting said specific user account to said repetition frequency of said specific event/item with said time management module.

12. The method of managing personal matters and personal interactions through a personal network by executing computer-executable instructions stored on a non-transitory computer-readable medium, the method as claimed in claim 11 further comprises the step of:
enabling each of said plurality of user accounts to track and manage said start date, said end date, and said repetition frequency of each of plurality of events/items with said calendar module.

13. The method of managing personal matters and personal interactions through a personal network by executing computer-executable instructions stored on a non-transitory computer-readable medium, the method as claimed in claim 9 further comprises the steps of:
enabling said first user account to set a required action for said specific event/item with said action management module; and
alerting said specific user account to said required action of specific event/item with said action management module.

14. The method of managing personal matters and personal interactions through a personal network by executing computer-executable instructions stored on a non-transitory computer-readable medium, the method as claimed in claim 1 further comprises the steps of:
providing a plurality of attributes for each of said plurality of user accounts, wherein each of said plurality attributes comprises each of said plurality of events/items, each of said plurality of classes, and each of said plurality of categories;
organizing said metric data of each of said plurality of user accounts by providing an average rating for each of said plurality of attributes;
organizing said performance data of each of said plurality of user account by providing a total number of completions for each of said plurality of attributes;
receiving an options request for an unfinished attribute from said first user account;
generating a list of proposed options for said unfinished attribute in order to maximize said metric data and said performance data of said first user account;
displaying said list of proposed options to said first user account with said display module;
prompting said first user account to choose from said list of proposed options with said user interface module in order to complete said unfinished attribute;
updating said metric data of said first user account with said metric module, if said unfinished attribute is completed by said first user account; and
updating said performance data of said first user account with said performance analysis module, if said unfinished attribute is completed by said first user account.

15. The method of managing personal matters and personal interactions through a personal network by executing computer-executable instructions stored on a non-transitory computer-readable medium, the method as claimed in claim 14 further comprises the steps of:
searching through said plurality of attributes to determine similar attributes with highest average rating in order to generate said list of proposed options;
searching through said plurality of attributes to determine similar attributes with highest total number of completions in order to generate said list of proposed options;
prompting said first user account to input user knowledge in order to generate said list of proposed options; and
retrieving expert knowledge and internet knowledge in order to generate said list of proposed options.

16. The method of managing personal matters and personal interactions through a personal network by executing computer-executable instructions stored on a non-transitory computer-readable medium, the method as claimed in claim 1 further comprises the steps of:
enabling each of said plurality of user accounts to search for a new user account with said find-friend module, wherein said new user account cannot access said personal network;
enabling each of said plurality of user accounts to send an invitation for said personal network to said new user account with said invite-friend module;
prompting said new user account to join said personal network through said invitation; and
adding said new user account to said plurality of user accounts, if said new user account agrees to join said personal network.

17. The method of managing personal matters and personal interactions through a personal network by executing computer-executable instructions stored on a non-transitory computer-readable medium, the method as claimed in claim 1 further comprises the steps of:
retrieving a new utility module for said personal network engine with said module-adding module; and
adding said new utility module to said plurality of modules with said module-adding module.

18. The method of managing personal matters and personal interactions through a personal network by executing computer-executable instructions stored on a non-transitory computer-readable medium, the method as claimed in claim 1 further comprises the steps of:
retrieving audiovisual data from said first user account with said user interface module; and
enabling said first user account to create an album and organize said audiovisual data into said album with said album module.

19. The method of managing personal matters and personal interactions through a personal network by executing computer-executable instructions stored on a non-transitory computer-readable medium, the method as claimed in claim 1 further comprises the steps of:
compiling and updating a list of contacts from said other user accounts with said contacts management module;
displaying said list of contacts to said first user account with said display module;
enabling said first user account to separate said user information into said public information, selectively public information, and private information with said privacy management module;
enabling said first user account to share said public information with said other user accounts through said privacy management module;
prompting said first user account to select privy user accounts from said other user accounts with said privacy management module;
enabling said first user account to exclusively share said selectively public information with said privy user accounts through said privacy management module; and
enabling said first user account to seclude said other user accounts from viewing and accessing said private information with said privacy management module.

20. The method of managing personal matters and personal interactions through a personal network by executing computer-executable instructions stored on a non-transitory computer-readable medium, the method as claimed in claim 19 further comprises the steps of:
retrieving a keyword from said second user account in order to search through said user information of said first user account;
searching through said public information of said first user account for said keyword with said search module;
searching through said selectively public information of said first user account for said keyword with said search module, if said privy user accounts includes said second user account; and
displaying search results of said keyword to said second user account with said display module.
